(19) United States
(12) Patent Application Publication
(10) Pub. No.: US 2026/0311400 A1
(43) Pub. Date: Oct. 8, 2026

(54) GROUND SURFACE COMPOSITE IMAGE CREATION METHOD, GROUND SURFACE COMPOSITE IMAGE CREATION SYSTEM, AND GROUND SURFACE COMPOSITE IMAGE CREATION PROGRAM

(71) Applicant: TOHOKU UNIVERSITY, Sendai-shi,Miyagi (JP)

(72) Inventors: Chinatsu YONEZAWA, Sendai-shi (JP); Koharu OKADA, Sendai-shi (JP)

(73) Assignee: TOHOKU UNIVERSITY, Sendai-shi,Miyagi (JP)

(21) Appl. No.: 19/481,612

(22) PCT Filed: May 15, 2024
(86) PCT No.: PCT/JP2024/017995

§ 371 Date: Nov. 5, 2025

(30) Foreign Application Priority Data
Jun. 21, 2023 (JP) 2023-101862

(51) Int. Cl. G06T 11/60; G06V 10/46

(52) U.S. Cl. CPC G06T 11/60; G06V 10/469

(57) ABSTRACT

A ground surface composite image creation method, a ground surface composite image creation system, and a ground surface composite image creation program that can relatively easily understand the utilization status of ground surfaces such as vegetation using height information. An ortho-image and a digital surface model of a target area are acquired, and a ground height image relating to heights of objects on the ground is created based on the digital surface model. Pixels having a ground height equal to or greater than a predetermined threshold value are extracted from the created ground height image. A grayscale image is created in which grayscale values of each extracted pixel are set based on corresponding ground heights or set to a constant value. A composite image is created by superimposing the created grayscale image on the ortho-image.

### FIELD OF THE INVENTION

The present invention relates to a ground surface composite image creation method, a ground surface composite image creation system, and a ground surface composite image creation program.

### DESCRIPTION OF RELATED ART

In recent years, as symbolized by the progress in certification of Globally Important Agricultural Heritage Systems and Japanese Nationally Important Agricultural Heritage Systems, attention to functions such as culture, landscape, and biodiversity possessed by rural villages has been increasing. For example, homestead forests are one of the main elements forming rural landscapes and also have roles for the surrounding environment such as conservation of biodiversity. For this reason, it is expected to perform quantitative evaluation and understanding of the current status of rural villages including homestead forests.

Conventionally, in order to understand the utilization status of ground surfaces by vegetation and the like and topography, a target area is consecutively photographed from different viewpoints in the sky using manned aircraft or unmanned aerial vehicles (UAV or drones), and the photographed images are processed by Structure from Motion (SfM) and the like, or the target area is measured from the sky with a Light Detection and Ranging (LiDAR) to acquire digital image data and measurement data, thereby obtaining ground surface images (ortho-images) and Digital Surface Models (DSM) generally.

Moreover, methods for detecting plants and the like on ground surfaces and understanding the utilization status of vegetation and the like on ground surfaces using the ortho-images and DSMs obtained in this way have been proposed. For example, a method of detecting target objects from DSM by artificial intelligence after obtaining DSM images of a target area and DSM images of target objects such as plants (for example, see Patent Literature 1), a method of obtaining slope amount maps and curvature maps based on DSM and synthesizing them with ortho-images to generate composite images that are more three-dimensional and have higher visibility than ortho-images (for example, see Patent Literature 2), a method of extracting the distribution of second type plants according to differences in plant heights thereof from DSM of fields having first type plants and second type plants (for example, see Patent Literature 3), a method of extracting feature quantities from laser measurement data and aerial photographs respectively for a target area including forests, and determining pixel values of color images at each pixel based on values of each feature quantity corresponding to each pixel, thereby visualizing differences in forest phases in color images (for example, see Patent Literature 4), and the like have been proposed.

### CITATION LIST

### Patent Literature

Patent Literature 1: Japanese Laid-Open Publication No. 2018-92628
Patent Literature 2: Japanese 6700519
Patent Literature 3: Japanese Laid-Open Publication No. 2022-66907
Patent Literature 4: Japanese Laid-Open Publication No. 2015-141118

### SUMMARY OF THE INVENTION

However, the method described in Patent Document 1 uses only image information of DSM and does not use ortho-images, resulting in a problem of poor detection efficiency of target objects. The method described in Patent Document 2 is effective for understanding topography and the like with the generated three-dimensional composite images with high visibility, but has a problem that it is difficult to understand the utilization status of ground surfaces such as vegetation. The method described in Patent Document 3 is for fields having only two types of plants, and has a problem that it is difficult to understand the utilization status in target areas such as rural villages other than fields. The method described in Patent Document 4 can set various feature quantities to be extracted, but has a problem that procedures and formulas for determining pixel values of color images become complicated.

The present invention has been made in view of such problems, and an objective of the present invention is to provide a ground surface composite image creation method, a ground surface composite image creation system, and a ground surface composite image creation program that can relatively easily understand the utilization status of ground surfaces such as vegetation using height information.

### Means for Solving the Problem

In order to achieve the above objective, a ground surface composite image creation method according to the present invention comprises an image acquisition step of acquiring an ortho-image and a Digital Surface Model (DSM) of a target area, a ground height image creation step of creating a ground height image relating to heights of objects on the ground based on the digital surface model acquired in the image acquisition step, a pixel extraction step of extracting pixels having a ground height equal to or greater than a predetermined threshold value from the ground height image created in the ground height image creation step, a grayscale image creation step of creating a grayscale image in which grayscale values of each pixel extracted in the pixel extraction step are set based on corresponding ground heights or set to a constant value, and a composite image creation step of creating a composite image by superimposing the grayscale image created in the grayscale image creation step on the ortho-image.

A ground surface composite image creation system according to the present invention comprises image acquisition means for acquiring an ortho-image and a digital surface model of a target area, ground height image creation means for creating a ground height image relating to heights of objects on the ground based on the digital surface model acquired by the image acquisition means, pixel extraction means for extracting pixels having a ground height equal to or greater than a predetermined threshold value from the ground height image created by the ground height image creation means, grayscale image creation means for creating a grayscale image in which grayscale values of each pixel extracted by the pixel extraction means are set based on corresponding ground heights or set to a constant value, and composite image creation means for creating a composite image by superimposing the grayscale image created by the grayscale image creation means on the ortho-image.

A ground surface composite image creation program according to the present invention causes a computer to function as image acquisition means for acquiring an ortho-image and a digital surface model of a target area, ground height image creation means for creating a ground height image relating to heights of objects on the ground based on the digital surface model acquired by the image acquisition means, pixel extraction means for extracting pixels having a ground height equal to or greater than a predetermined threshold value from the ground height image created by the ground height image creation means, grayscale image creation means for creating a grayscale image in which grayscale values of each pixel extracted by the pixel extraction means are set based on corresponding ground heights or set to a constant value, and composite image creation means for creating a composite image by superimposing the grayscale image created by the grayscale image creation means on the ortho-image.

The ground surface composite image creation method, the ground surface composite image creation system, and the ground surface composite image creation program according to the present invention can easily obtain a composite image reflecting height information by setting grayscale of an ortho-image of a target area based on ground heights representing heights of objects on the ground. Moreover, by using the composite image, it is possible to make judgments including not only appearance from above but also height differences, and the utilization status of ground surfaces such as vegetation can be understood relatively easily. Moreover, even when the resolution of the ortho-image is low, extraction accuracy of vegetation and the like can be improved. Note that ground height refers to heights from the ground of objects on the ground such as buildings and trees.

Since the ground surface composite image creation method, the ground surface composite image creation system, and the ground surface composite image creation program according to the present invention create a composite image in which height information is reflected in grayscale of an ortho-image, the composite image can be obtained as a three-channel image of red, green, and blue. For example, general image processing programs using machine learning and the like are developed on the premise of processing RGB three-channel images, and images captured by ordinary cameras mounted on UAVs are also three-channel images. Therefore, the ground surface composite image creation method, the ground surface composite image creation system, and the ground surface composite image creation program according to the present invention do not need to convert three-channel images to multi-channel images of four or more channels or modify image processing programs for multi-channels of four or more channels, and have high versatility.

The composite image created by the ground surface composite image creation method, the ground surface composite image creation system, and the ground surface composite image creation program according to the present invention may be used for machine learning as training data together with the utilization status of ground surfaces such as vegetation understood from the composite image, in order to construct a system for understanding the utilization status of ground surfaces such as vegetation. Moreover, the utilization status of ground surfaces such as vegetation may be understood from newly created composite images using the system constructed in this way. In the ground surface composite image creation method, the ground surface composite image creation system, and the ground surface composite image creation program according to the present invention, it is preferable that each pixel of the ground height image and the grayscale image corresponds to each pixel of the ortho-image in a 1:1 relationship, but they do not necessarily have to correspond in a 1:1 relationship as long as positions of each image do not shift from each other.

In the ground surface composite image creation method according to the present invention, the grayscale image creation step may set each grayscale value to a constant value so that each pixel extracted in the pixel extraction step becomes white. In the ground surface composite image creation system and the ground surface composite image creation program according to the present invention, the grayscale image creation means may set each grayscale value to a constant value so that each pixel extracted by the pixel extraction means becomes white. In this case, since portions with ground heights equal to or greater than a predetermined threshold value become white in the created composite image, portions higher than the threshold value can be easily extracted. Therefore, for example, when a region such as a rural village is set as a target area, it is very difficult to distinguish between plantings such as hedges lower than houses and homestead forests that have grown taller than houses in images photographed from above, but in a composite image obtained by setting a predetermined threshold value higher than the height of houses, only homestead forests can be easily extracted.

Moreover, in the ground surface composite image creation method according to the present invention, the grayscale image creation step may set grayscale values of each pixel extracted in the pixel extraction step to values obtained by converting corresponding ground heights with a predetermined monotonically increasing function or monotonically decreasing function. In the ground surface composite image creation system and the ground surface composite image creation program according to the present invention, the grayscale image creation means may set grayscale values of each pixel extracted by the pixel extraction means to values obtained by converting corresponding ground heights with a predetermined monotonically increasing function or monotonically decreasing function. In this case, since the ground height image is contrast-converted according to ground heights of each pixel and reflected in grayscale of the composite image, height information can be easily understood from the created composite image. Therefore, differences in vegetation and the like that are difficult to understand from appearance from above alone can be easily extracted using the composite image.

In the ground surface composite image creation method according to the present invention, the ground height image creation step may create a Digital Elevation Model (DEM) based on the digital surface model, and create the ground height image from a difference between the digital surface model and the created digital elevation model. Alternatively, the image acquisition step may also acquire a digital elevation model of the target area, and the ground height image creation step may create the ground height image from a difference between the digital surface model and the digital elevation model acquired in the image acquisition step. In the ground surface composite image creation system and the ground surface composite image creation program according to the present invention, the ground height image creation means may create a digital elevation model based on the digital surface model, and create the ground height image from a difference between the digital surface model and the created digital elevation model. Alternatively, the image acquisition means may also acquire a digital elevation model of the target area, and the ground height image creation means may create the ground height image from a difference between the digital surface model and the digital elevation model acquired by the image acquisition means.

When using this digital elevation model, when creating a digital elevation model based on a digital surface model, for example, the digital elevation model can be created by performing filtering on the digital surface model to remove heights of objects on the ground such as buildings and trees. Moreover, when acquiring a digital elevation model in the image acquisition step or by the image acquisition means, for example, a digital elevation model provided by the Geospatial Information Authority of Japan or the like can be used. Moreover, by using a digital elevation model, a ground height image can be easily created from a difference between a Digital Surface Model (DSM) and a Digital Elevation Model (DEM). The ground height image to be created is, for example, an image based on a Digital Height Model (DHM).

In the ground surface composite image creation method according to the present invention, the image acquisition step may acquire three-dimensional point cloud data from image data obtained by photographing the target area from above, and create the ortho-image and the digital surface model from the acquired three-dimensional point cloud data. In the ground surface composite image creation system and the ground surface composite image creation program according to the present invention, the image acquisition means may acquire three-dimensional point cloud data from image data obtained by photographing the target area from above, and create the ortho-image and the digital surface model from the acquired three-dimensional point cloud data. In this case, for example, three-dimensional point cloud data can be easily acquired by processing with Structure from Motion (SfM) or the like using image data consecutively photographed from different viewpoints in the sky by a UAV.

Moreover, in the ground surface composite image creation method according to the present invention, the image acquisition step may create the ortho-image and the digital surface model based on aerial photographs obtained by photographing the target area from above and measurement data obtained by measuring the target area from above with a Light Detection and Ranging (LiDAR). In the ground surface composite image creation system and the ground surface composite image creation program according to the present invention, the image acquisition means may create the ortho-image and the digital surface model based on aerial photographs obtained by photographing the target area from above and measurement data obtained by measuring the target area from above with a Light Detection and Ranging (LiDAR). In this case, the ortho-image and the digital surface model can be created using aerial photographs and measurement data by a Light Detection and Ranging (LiDAR) without using a UAV.

The ground surface composite image creation method according to the present invention preferably has a composite image display step of displaying the composite image created in the composite image creation step. The ground surface composite image creation system according to the present invention preferably has composite image display means for displaying the composite image created by the composite image creation means. The ground surface composite image creation program according to the present invention preferably causes a computer to further function as composite image display means for displaying the composite image created by the composite image creation means. In this case, the utilization status of ground surfaces such as vegetation can be understood using the displayed composite image.

Since the ground surface composite image creation method, the ground surface composite image creation system, and the ground surface composite image creation program according to the present invention understand the utilization status of ground surfaces such as vegetation using height information, they are preferably used in regions where ground elevation differences are small, such as rural villages. The ground surface composite image creation method, the ground surface composite image creation system, and the ground surface composite image creation program according to the present invention can be used, for example, for understanding distributions of homestead forests, park trees and plantings, understanding distributions of artificial objects such as buildings and solar panels, understanding fallen trees due to disasters, and management thereof. Therefore, they are suitable for use in environmental consulting businesses, environmental information processing service businesses, construction businesses, aerial surveying businesses, agriculture, forestry and fisheries industries, and the like.

### Effects of the Invention

According to the present invention, it is possible to provide a ground surface composite image creation method, a ground surface composite image creation system, and a ground surface composite image creation program that can relatively easily understand the utilization status of ground surfaces such as vegetation using height information.

### BRIEF DESCRIPTION OF DRAWINGS

FIG. 1 is a block diagram showing a configuration of a ground surface composite image creation system according to an embodiment of the present invention.

FIG. 2 is a flowchart showing a processing procedure of the ground surface composite image creation system according to the embodiment of the present invention.

FIG. 3 (a) shows an ortho-image created with a certain rural village as a target area, (b) shows a grayscale image of (1) created in the target area of (a), (c) shows a grayscale image of (2) created in the target area of (a), and (d) shows a composite image created by superimposing the ortho-image of (a) and the grayscale image of (b) in the ground surface composite image creation system according to the embodiment of the present invention.

### DETAILED DESCRIPTION OF THE INVENTION

Hereinafter, embodiments of the present invention will be described based on the drawings.

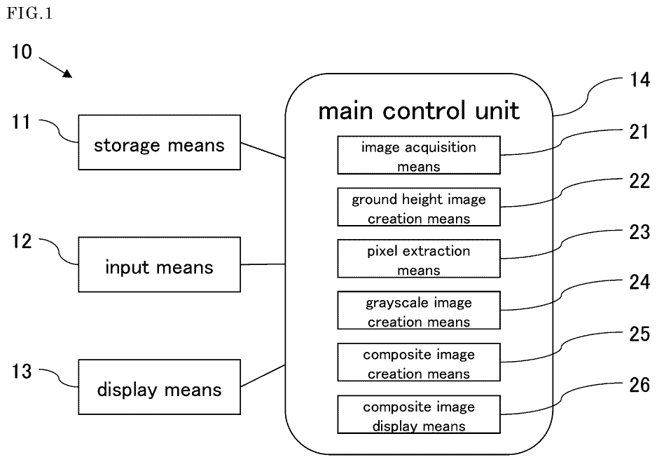

FIGS. 1 to 3 show a ground surface composite image creation method, a ground surface composite image creation system, and a ground surface composite image creation program according to embodiments of the present invention. The ground surface composite image creation method according to the embodiment of the present invention is a method suitably implemented by the ground surface composite image creation system according to the embodiment of the present invention, and can be executed by a computer using the ground surface composite image creation program.

As shown in FIG. 1, a ground surface composite image creation system 10 according to the embodiment of the present invention comprises a computer and has storage means 11, input means 12, display means 13, and a main control unit 14. The storage means 11 comprises a memory capable of storing various data. The input means 12 comprises a keyboard, a mouse, and the like for a user to input various data and information. The display means 13 comprises a monitor (display). The main control unit 14 comprises a CPU and has calculation functions and control functions. The main control unit 14 is connected to the input means 12, the storage means 11, and the display means 13, and is configured to be able to control each of them.

The storage means 11 is configured to store digital aerial image data obtained by photographing a target area from above, aerial photographs obtained by photographing a target area from above, measurement data obtained by measuring a target area from above with a Light Detection and Ranging (LiDAR), and the like, which are acquired in advance by a UAV. The aerial image data by the UAV comprises a plurality of data consecutively photographed from different viewpoints in the sky. Moreover, the storage means 11 is also configured to store three-dimensional point cloud data, ortho-images, Digital Surface Models (DSM), ground height images, grayscale images, composite images, and the like created by the main control unit 14. Moreover, the storage means 11 may be configured to store a Digital Elevation Model (DEM) of a target area provided by the Geospatial Information Authority of Japan or the like, which is acquired in advance via the Internet or the like.

The input means 12 is configured to input a set threshold value and to instruct a method for creating a grayscale image. The display means 13 is configured to be able to display aerial image data stored in the storage means 11, ortho-images, digital surface models, digital elevation models, ground height images, grayscale images, composite images, and the like.

The main control unit 14 has image acquisition means 21, ground height image creation means 22, pixel extraction means 23, grayscale image creation means 24, composite image creation means 25, and composite image display means 26. The image acquisition means 21 is configured to acquire three-dimensional point cloud data by processing a plurality of aerial image data stored in the storage means 11 with Structure from Motion (SfM), create an ortho-image and a digital surface model of a target area from the three-dimensional point cloud data, and create a digital surface model from measurement data by LiDAR stored in the storage means 11. Moreover, the image acquisition means 21 may be configured to acquire a digital elevation model from the storage means 11. The created ortho-image is an RGB three-channel image.

The ground height image creation means 22 is configured to create a ground height image relating to heights of objects on the ground based on the digital surface model acquired by the image acquisition means 21. The ground height image creation means 22 may, for example, create a digital elevation model based on the digital surface model and create the ground height image from a difference between the digital surface model and the created digital elevation model. Alternatively, the ground height image creation means 22 may create the ground height image from a difference between the digital surface model and the digital elevation model acquired by the image acquisition means. In these cases, the ground height image to be created becomes an image based on a Digital Height Model (DHM).

The pixel extraction means 23 is configured to extract pixels having a ground height equal to or greater than a predetermined threshold value input by the input means 12 from the ground height image created by the ground height image creation means 22.

The grayscale image creation means 24 is configured to set grayscale values of each pixel extracted by the pixel extraction means 23 from the ground height image created by the ground height image creation means 22 according to the following (1) and (2), and create respective gray scale images.

(1) Set grayscale values of each pixel to a constant value so that each pixel extracted by the pixel extraction means 23 becomes white.

(2) Set grayscale values of each pixel extracted by the pixel extraction means 23 to values obtained by converting corresponding ground heights with a predetermined monotonically increasing function or monotonically decreasing function.

The composite image creation means 25 is configured to create a composite image by superimposing the gray scale image of (1) or the grayscale image of (2) created by the grayscale image creation means 24 on the ortho-image created by the image acquisition means 21, based on a selection input by the input means 12. The composite image display means 26 is configured to display the composite image created by the composite image creation means 25 on the display means 13.

In the ground surface composite image creation system 10 according to the embodiment of the present invention, each pixel not extracted by the pixel extraction means 23 is set to black (pixel value of zero), and grayscale values of the ortho-image created by the image acquisition means 21 are configured to become grayscale values of the composite image as they are. When creating the grayscale image of (1), it may be set so that each pixel extracted by the pixel extraction means 23 becomes black and each pixel not extracted by the pixel extraction means 23 becomes white.

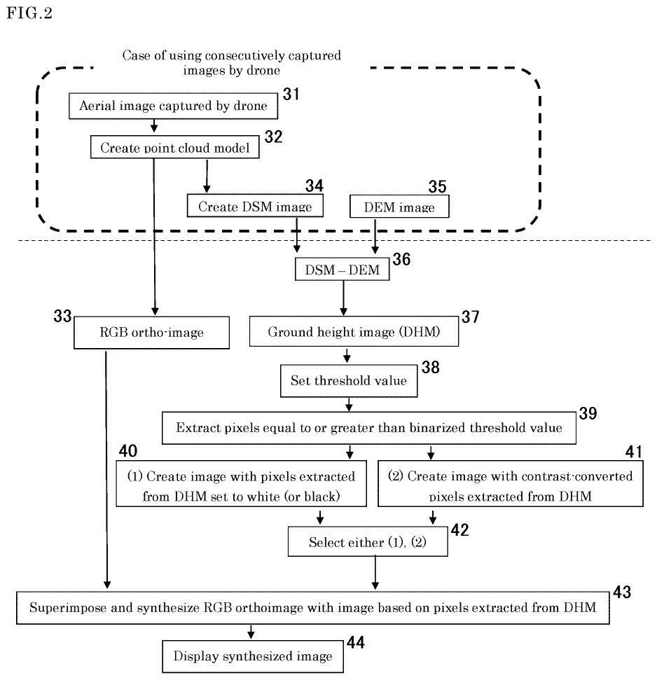

Next, a processing procedure and operation of the ground surface composite image creation system 10 according to the embodiment of the present invention will be described with reference to FIG. 2.

As shown in FIG. 2, when using a UAV (drone), first, a target area is consecutively photographed from different viewpoints in the sky in advance, and a plurality of acquired aerial image data are stored in the storage means 11 (Step 31). Next, each aerial image data stored in the storage means 11 is processed with SfM by the image acquisition means 21 to create three-dimensional point cloud data (Step 32). Furthermore, the image acquisition means 21 creates an ortho-image (Step 33) and a digital surface model (DSM image) (Step 34) of the target area from the three-dimensional point cloud data.

The ground height image creation means 22 obtains difference data (DSM-DEM) between the DSM image and the DEM image (Step 36) using the digital surface model and a digital elevation model (DEM image) (Step 35) provided from a provider such as the Geospatial Information Authority of Japan and stored in the storage means 11, and creates a ground height image (DHM) (Step 37).

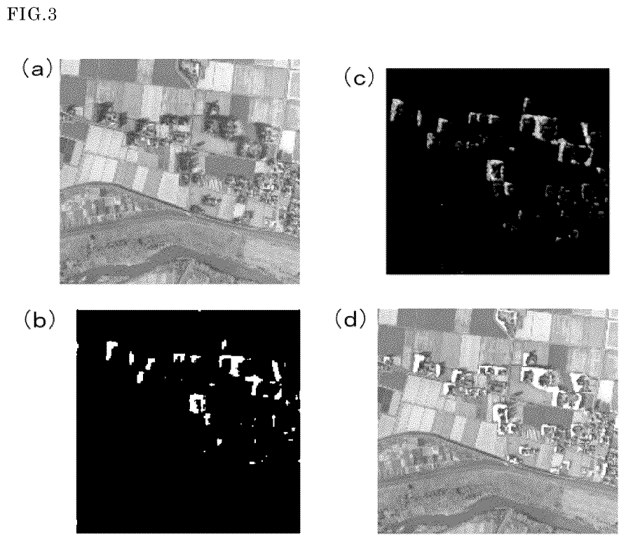

Moreover, when using aerial photographs and measurement data by LiDAR without using a UAV (drone), the image acquisition means 21 creates an ortho-image by orthorectifying aerial photographs stored in the storage means 11 (Step 33) and creates a digital surface model (DSM image) from measurement data by LiDAR stored in the storage means 11. The ground height image creation means 22 creates a digital elevation model (DEM image) by performing filtering on the digital surface model to remove heights of objects on the ground such as buildings and trees, obtains difference data (DSM-DEM) between the DSM image and the DEM image (Step 36), and creates a ground height image (DHM) (Step 37). Here, when creating the ortho-image, aerial photographs may be orthorectified using the DEM image created by the ground height image creation means 22. An example of an aerial photograph of a certain rural village as a target area is shown in FIG. 3(a).

A threshold value of ground height is set with reference to the ortho-image, the created DSM image, DEM image, ground height image, and the like, and the threshold value is input from the input means 12 (Step 38). The pixel extraction means 23 extracts pixels having a ground height equal to or greater than the input threshold value from the ground height image (Step 39).

The grayscale image creation means 24 sets grayscale values of each pixel to a constant value so that each extracted pixel becomes white, and creates a grayscale image of (1) according to the setting (Step 40). Furthermore, the grayscale image creation means 24 sets grayscale values of each extracted pixel to values obtained by converting corresponding ground heights with a predetermined monotonically increasing function or monotonically decreasing function using a contrast conversion technique, and creates a grayscale image of (2) according to the setting (Step 41). At this time, each pixel not extracted by the pixel extraction means 23 is set to black (pixel value of zero) (binarization). Examples of the grayscale image of (1) and the grayscale image of (2) in the target area of FIG. 3(a) are shown in FIG. 3(b) and (c), respectively. In FIG. 3(b) and (c), a ground height that is higher than plantings such as hedges and houses but lower than homestead forests is set as the threshold value. FIG. 3(b) and (c) are images obtained when using aerial photographs and measurement data by LiDAR.

When creating the grayscale image of (2), a monotonically increasing function or monotonically decreasing function for converting ground heights to grayscale values may be set in advance, or which monotonically increasing function or monotonically decreasing function to use may be instructed from the input means 12. Moreover, the monotonically increasing function and the monotonically decreasing function may be linear functions or nonlinear functions, or may be functions combining them.

The grayscale image of (1) or the grayscale image of (2) is selected by referring to the created grayscale image of (1) and grayscale image of (2), and the selection is input from the input means 12 (Step 42). The composite image creation means 25 superimposes the grayscale image of (1) or the grayscale image of (2) selected by input from the input means 12 on the ortho-image to create a composite image (Step 43). The composite image display means 26 sends the composite image created by the composite image creation means 25 to the display means 13, and the display means 13 displays the composite image (Step 44). Thereby, the utilization status of ground surfaces such as vegetation can be understood using the displayed composite image.

An example of a composite image in the target area of FIG. 3(a) is shown in FIG. 3(d). The composite image of FIG. 3(d) is obtained by superimposing the grayscale image of (1) on the ortho-image. According to such a composite image created by superimposing the grayscale image of (1) on the ortho-image, since portions with ground heights equal to or greater than a predetermined threshold value become white, portions higher than the threshold value can be easily extracted. Therefore, for example, when a region such as a rural village is set as a target area, it is very difficult to distinguish between plantings such as hedges lower than houses and homestead forests that have grown taller than houses in images photographed from above (for example, the image of FIG. 3(a)), but in a composite image obtained by setting a predetermined threshold value higher than the height of houses, only homestead forests can be easily extracted. For example, from the composite image of FIG. 3(d), white portions can be easily extracted as homestead forests.

Moreover, according to a composite image created by superimposing the grayscale image of (2) on the ortho-image, since a range of ground heights equal to or greater than a predetermined threshold value is contrast-converted and reflected in grayscale of the composite image, height information can be easily understood from the created composite image. Therefore, differences in vegetation and the like that are difficult to understand from appearance from above alone can also be easily extracted from a composite image created by superimposing the grayscale image of (2) on the ortho-image.

The ground surface composite image creation system 10 according to the embodiment of the present invention can easily obtain a composite image reflecting height information by setting grayscale of an ortho-image of a target area based on ground heights. Moreover, by using the composite image, it is possible to make judgments including not only appearance from above but also height differences, and the utilization status of ground surfaces such as vegetation can be understood relatively easily. Moreover, even when the resolution of the ortho-image is low, extraction accuracy of vegetation and the like can be improved.

Since the ground surface composite image creation system 10 according to the embodiment of the present invention creates a composite image in which height information is reflected in grayscale of an ortho-image, the composite image can be obtained as an RGB three-channel image. Therefore, there is no need to convert three-channel images to multi-channel images of four or more channels or modify image processing programs for multi-channels of four or more channels, and versatility is high.

The composite image created by the ground surface composite image creation system 10 according to the embodiment of the present invention may be used for machine learning as training data together with data of the utilization status of ground surfaces such as vegetation understood from the composite image, in order to construct a ground surface utilization status estimation system for understanding the utilization status of ground surfaces such as vegetation. Moreover, the utilization status of ground surfaces such as vegetation may be understood from newly created composite images using the ground surface utilization status estimation system constructed in this way.

### Example 1

Using the ground surface composite image creation system 10 according to the embodiment of the present invention, composite images were created for a plurality of regions. Images obtained by dividing the composite images into multiple parts were divided into training data and test data, machine learning was performed using the training data (actual distribution of homestead forests), and an estimation system for distribution status of homestead forests was constructed. Next, accuracy evaluation of homestead forest extraction was performed on the constructed system using the test data. A Dice coefficient was used for accuracy evaluation. As a comparative example, without using the ground surface composite image creation system 10 according to the embodiment of the present invention, images obtained by dividing only ortho-images into multiple parts were used as training data and test data, and machine learning and accuracy evaluation were performed.

As a result, the Dice coefficient in the comparative example where homestead forest extraction was performed using only ortho-images was 0.64. In contrast, the Dice coefficient when homestead forest extraction was performed with a composite image using the grayscale image of (1) was 0.76. Moreover, the Dice coefficient when homestead forest extraction was performed with a composite image using the grayscale image of (2) was 0.80. When creating the grayscale image of (2), linear transformation was used as contrast conversion. From these results, it can be said that extraction accuracy can be improved by using composite images.

The ground surface composite image creation program according to the embodiment of the present invention may be provided, for example, from outside via a communication line, or may be provided in a form recorded on computer-readable recording media such as CDs (CD-ROM, CD-R, CD-RW, etc.), DVDs (DVD-ROM, DVD-RAM, DVD-R, DVD-RW, DVD+R, DVD+RW, etc.), USB memories, and the like. In these cases, a computer can read the ground surface composite image creation program from the communication line or recording medium, transfer and store it in an internal storage device of the computer for use. Moreover, the ground surface composite image creation program according to the embodiment of the present invention may be recorded in storage devices (recording media) such as magnetic disks, optical disks, magneto-optical disks, and the like, and provided to a computer from the storage device via a communication line.

Here, a computer is a concept including hardware and an OS (operating system), and means hardware operating under control of the OS. Moreover, when an OS is unnecessary and an application program alone operates hardware, the hardware itself corresponds to a computer. Hardware comprises at least a microprocessor such as a CPU and means for reading a computer program recorded in an internal storage device or recording medium.

An application program as the ground surface composite image creation program according to the embodiment of the present invention includes program code for causing a computer as described above to realize. Moreover, part of the functions may be realized by an OS rather than an application program.

### REFERENCE SIGNS LIST

10 Ground surface composite image creation system
11 Storage means
12 Input means
13 Display means
14 Main control unit
21 Image acquisition means
22 Ground height image creation means
23 Pixel extraction means
24 Grayscale image creation means
25 Composite image creation means
26 Composite image display means

1. A ground surface composite image creation method comprising:
an image acquisition step of acquiring an ortho-image and a Digital Surface Model (DSM) of a target area;
a ground height image creation step of creating a ground height image relating to heights of objects on the ground based on the digital surface model acquired in the image acquisition step;
a pixel extraction step of extracting pixels having a ground height equal to or greater than a predetermined threshold value from the ground height image created in the ground height image creation step;
a grayscale image creation step of creating a grayscale image in which grayscale values of each pixel extracted in the pixel extraction step are set based on corresponding ground heights or set to a constant value; and
a composite image creation step of creating a composite image by superimposing the grayscale image created in the grayscale image creation step on the ortho-image.

2. The ground surface composite image creation method according to claim 1, wherein the grayscale image creation step sets each grayscale value to a constant value so that each pixel extracted in the pixel extraction step becomes white.

3. The ground surface composite image creation method according to claim 1, wherein the grayscale image creation step sets grayscale values of each pixel extracted in the pixel extraction step to values obtained by converting corresponding ground heights with a predetermined monotonically increasing function or monotonically decreasing function.

4. The ground surface composite image creation method according to claim 1, wherein the ground height image creation step creates a Digital Elevation Model (DEM) based on the digital surface model, and creates the ground height image from a difference between the digital surface model and the created digital elevation model.

5. The ground surface composite image creation method according to claim 1, wherein:
the image acquisition step also acquires a digital elevation model of the target area; and
the ground height image creation step creates the ground height image from a difference between the digital surface model and the digital elevation model acquired in the image acquisition step.

6. The ground surface composite image creation method according to claim 1, wherein the image acquisition step acquires three-dimensional point cloud data from image data obtained by photographing the target area from above, and creates the ortho-image and the digital surface model from the acquired three-dimensional point cloud data.

7. The ground surface composite image creation method according to claim 1, wherein the image acquisition step creates the ortho-image and the digital surface model based on aerial photographs obtained by photographing the target area from above and measurement data obtained by measuring the target area from above with a Light Detection and Ranging (LiDAR).

8. The ground surface composite image creation method according to claim 1, comprising a composite image display step of displaying the composite image created in the composite image creation step.

9. A ground surface composite image creation system comprising:
image acquisition means for acquiring an ortho-image and a digital surface model of a target area;
ground height image creation means for creating a ground height image relating to heights of objects on the ground based on the digital surface model acquired by the image acquisition means;
pixel extraction means for extracting pixels having a ground height equal to or greater than a predetermined threshold value from the ground height image created by the ground height image creation means;
grayscale image creation means for creating a grayscale image in which grayscale values of each pixel extracted by the pixel extraction means are set based on corresponding ground heights or set to a constant value; and
composite image creation means for creating a composite image by superimposing the grayscale image created by the grayscale image creation means on the ortho-image.

10. A ground surface composite image creation program for causing a computer to function as:
image acquisition means for acquiring an ortho-image and a digital surface model of a target area;
ground height image creation means for creating a ground height image relating to heights of objects on the ground based on the digital surface model acquired by the image acquisition means;
pixel extraction means for extracting pixels having a ground height equal to or greater than a predetermined threshold value from the ground height image created by the ground height image creation means;
grayscale image creation means for creating a grayscale image in which grayscale values of each pixel extracted by the pixel extraction means are set based on corresponding ground heights or set to a constant value; and
composite image creation means for creating a composite image by superimposing the grayscale image created by the grayscale image creation means on the ortho-image.
